(19) United States
(12) Patent Application Publication
(10) Pub. No.: US 2013/0329773 A1
(43) Pub. Date: Dec. 12, 2013

(54) RECEIVER AND METHOD OF CONTROLLING A RECEIVER

(71) Applicant: Agency for Science, Technology and Research, Singapore (SG)

(72) Inventors: Kuang-Wei Cheng, Singapore (SG); Zhiming Chen, Singapore (SG); Yuanjin Zheng, Singapore (SG); Rui-Feng Xue, Singapore (SG); Minkyu Je, Singapore (SG)

(21) Appl. No.: 13/912,803

(22) Filed: Jun. 7, 2013

(30) Foreign Application Priority Data
Jun. 8, 2012 (SG) 201204245-3

(51) Int. Cl. H04L 27/00

(52) U.S. Cl. CPC H04L 27/0014
USPC 375/219; 375/343

(57) ABSTRACT

According to embodiments of the present invention, a receiver is provided. The receiver includes an envelope detector configured to generate a waveform corresponding to an envelope of a signal received by the receiver, a carrier recovery circuit configured to generate a carrier signal based on the waveform, wherein the carrier signal has a frequency corresponding to a center frequency of the received signal, and a template generator configured to generate a local template signal based on the waveform, the local template signal including a plurality of pulses. According to further embodiments of the present invention, a method of controlling a receiver is also provided.

### CROSS-REFERENCE TO RELATED APPLICATION

This application claims the benefit of priority of Singapore patent application No. 201204245-3, filed 8 Jun. 2012, the content of it being hereby incorporated by reference in its entirety for all purposes.

### TECHNICAL FIELD

Various embodiments relate to a receiver, a transceiver including the receiver and a method of controlling the receiver.

### BACKGROUND

In recent decades, neural prostheses have become widely utilized in the areas of cochlear implants and visual prostheses. These biomedical implants interface with the central nervous system with a large number of neurons through multiple channels where large amounts of data are needed to be transmitted simultaneously. A current limitation of this technology is the way in which recorded neural signals are transferred from the recording device, which is ideally implanted in the body, to signal processing equipment used for scientific or neuroprosthetic applications. A wireless link is necessary to avoid transcutaneous wires which present a high risk of infection, device failure, and discomfort to the patient. A high data-rate transmission is highly needed for the wireless implantable neural recording devices.

Ultra-wide band (UWB) signaling allows very low power levels and has abilities for very high data rate for short range communications. Impulse radio (IR) communication is a specific form of UWB where data is modulated on short pulses in time. Short pulse separated by silent periods yield a low average power output, but the high instantaneous power spread across a large bandwidth provides insensitivity to narrowband interference. This form has a high robustness against fading and multipath channels, and allows the use of fairly simple, low power transceiver designs. The design should have low complexity and can be integrated in complementary metal-oxide-semiconductor (CMOS) technology to realize miniaturization with a few or no off-chip components. These features make UWB impulse radio a charming candidate for high data rate biomedical telemetry.

The impulse-radio UWB allows the transfer of the analog-to-digital converter (ADC) close to the antenna after the low noise amplifier (LNA), thereby making it possible to do the signal recovery and demodulation in digital domain. However, this may not provide a low-power solution due to the required high speed Nyquist-rate ADC. The way to reduce power consumption is to move the ADC down and place it next to the time-domain correlator, and perform the down-conversion or the time-domain correlation subsystem using analog techniques. However, since the duty cycle of time domain UWB signal is low, carrier or template generation is required to align the active receiver window with the transmitter pulses, requiring a considerable amount of baseband hardware. Generation of these short duration pulses also requires dedicated and power-hungry hardware and complex algorithm. Conventional template generation requires area- and power-hungry digital back-end for timing control and external reference crystal oscillator for a phase-locked loop (PLL) for carrier recovery.

UWB is a promising technology for short range indoor data communications. From an implementation point of view, several solutions have been developed in order to use the UWB technology in compliance with Federal Communications Commission (FCC)'s regulatory requirements. These approaches, being non-coherent, avoid the implementation of sophisticated channel estimations with the drawback of reduced sensitivity, noise and interference rejection but with the advantage of very low power consumption.

One example of a UWB-IR receiver architecture is a fully digital receiver which directly samples the wideband pulses at the Nyquist rate. As a result, all processing can be done in the digital domain, allowing a very flexible implementation and the use of very accurate pulse templates. However, due to the wide bandwidth signals employed, very fast ADCs at Nyquist rate and digital logic are required, which comes at a power penalty. This high power consumption is unacceptable in low power design. At the other end, energy detector UWB-IR receivers benefit from a low complexity and low power implementation, but suffer from large performance degradation due to the noise-cross-noise correlation term.

A clocked correlating receiver, which tries to balance its performance and power consumption, is among the most energy-efficient solutions. It allows low power consumptions, while maintaining good interference robustness. For the clocked correlating receiver, the received signal is correlated with template pulses. The power consumption of the quadrature analog correlation (QAC) receiver of the clocked correlating receiver is kept low by reducing the analog-to-digital converter (ADC) sampling rate to the pulse rate. To enable this, the generation and synchronization of the pulse template with the incoming pulses is moved to the analog domain. Generating the perfectly matched filtering template is not trivial and would require complex tuning with digital back-end to control the timing of synchronization template.

Modulation scheme is important when building up a communication system for low-power target. Amplitude shift keying (ASK) has been commonly used in many telemetry applications because of its simple form of modulation, where information is transmitted by modulating the amplitude of the power carrier. The advantage of this approach is that it can be used with a simple, non-coherent receiver. However, high data rate ASK would need high order filters with sharp cut-off frequencies. In addition, ASK performance also suffers from noise and interference. An alternative type of modulation that still permits simple and against interference is frequency shift keying (FSK). This has been used with a high modulation index to achieve high data rate and better noise immunity. A drawback of FSK is that a high data rate requires wide bandwidth, which reduces power transmission efficiency as compared to their narrowband counterpart. In UWB-IR, the nature of its ultra wide band would provide sufficient bandwidth for FSK modulation. As for phase shift keying (PSK), it is more spectrally efficient than FSK and as an alternative candidate to achieve high data rate. However, PSK requires more complex, coherent receiver implementation, leading to high power consumption.

There is therefore need for an approach (e.g. an ultra-wide band (UWB) technology) that is more straightforward to implement both at system and circuit level. There is also need for an energy efficient communication with high robustness for biomedical implants.

### SUMMARY

According to an embodiment, a receiver is provided. The receiver may include a an envelope detector configured to generate a waveform corresponding to an envelope of a signal received by the receiver, a carrier recovery circuit configured to generate a carrier signal based on the waveform, wherein the carrier signal has a frequency corresponding to a center frequency of the received signal, and a template generator configured to generate a local template signal based on the waveform, the local template signal including a plurality of pulses.

According to an embodiment, a transceiver is provided. The transceiver may include the receiver as described herein.

According to an embodiment, a method of controlling a receiver is provided. The method may include generating a waveform corresponding to an envelope of a signal received by the receiver, generating a carrier signal based on the waveform, wherein the carrier signal has a frequency corresponding to a center frequency of the received signal, and generating a local template signal based on the waveform, the local template signal including a plurality of pulses.

### BRIEF DESCRIPTION OF THE DRAWINGS

In the drawings, like reference characters generally refer to like parts throughout the different views. The drawings are not necessarily to scale, emphasis instead generally being placed upon illustrating the principles of the invention. In the following description, various embodiments of the invention are described with reference to the following drawings, in which:

FIG. 1A shows a schematic block diagram of a receiver, according to various embodiments.

FIG. 1B shows a schematic block diagram of a transceiver, according to various embodiments.

FIG. 1C shows a flow chart illustrating a method of controlling a receiver, according to various embodiments.

FIG. 2A shows a schematic block diagram of a transmitter, according to various embodiments.

FIG. 2B shows a schematic block diagram of a receiver, according to various embodiments.

FIG. 2C shows a schematic block diagram of an envelope detector, according to various embodiments.

FIGS. 3A to 3D show the transient response of the envelope detector of the embodiment of FIG. 2C.

FIG. 4A shows a plot of the measured transient responses of the receiver of various embodiments for a data rate of about 27.12 MHz.

FIG. 4B shows a plot of the measured transient responses of the receiver of various embodiments for a data rate of about 10.848 MHz.

FIGS. 5A and 5B show respectively a plot of local oscillator output spectrum and a plot of voltage-controlled oscillator (VCO) phase noise for a receiver with external 10 MHz reference and a center frequency, f_{c}, of about 450 MHz.

FIGS. 6A and 6B show respectively a plot of local oscillator output spectrum and a plot of voltage-controlled oscillator (VCO) phase noise for a receiver with internal 10 MHz envelope and a center frequency, f_{c}, of about 450 MHz.

FIG. 7 shows a plot of simulated bit error rate (BER) as a function of E_{b}/N₀ at a 10-Mbps data rate for the receiver of various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the methods or devices are analogously valid for the other method or device. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element includes a reference to one or more of the features or elements.

In the context of various embodiments, the phrase “at least substantially” may include “exactly” and a reasonable variance.

In the context of various embodiments, the term “about” or “approximately” as applied to a numeric value encompasses the exact value and a reasonable variance.

As used herein, the term “and/or” includes any and all combinations of one or more of the associated listed items.

Various embodiments may relate to wideband data transceiver integrated circuit (IC).

Various embodiments may provide a burst-mode or pulsed wideband receiver (e.g. burst-mode or pulsed wideband frequency shift keying (FSK) receiver) with auto-synchronization to the incoming signal or pulses (e.g. incoming template pulses). The receiver may meet the requirements for high-data-rate and low-power neural recording devices and may provide the required biomedical telemetry.

The burst-mode or pulsed wideband receiver using auto-synchronization technique of various embodiments may be employed as a substitute for the complex digital tuning hardware employed in conventional solutions. The technique of various embodiments may also be used for ultra-wideband impulse radio (UWB-IR) with FSK or PSK modulation, or other wideband radios where the synchronized template generation may be needed.

Various embodiments may feature auto-synchronization without a digital backend, and may achieve good power and area efficiency. Various embodiments may replace the complex algorithms and area- and power-hungry digital back-end processing of conventional devices with an analog carrier recovery approach. The carrier recovery circuitry of various embodiments not only provides synchronization with transmitter template pulses, but also removes the external reference crystal oscillator of the phase-locked loop (PLL) of conventional receivers. The techniques or approach of various embodiments of the crystal-less carrier recovery and the auto-synchronized template generation may be used for any burst-mode or pulsed wideband radios with frequency shift keying (FSK), including binary frequency shift keying (BFSK), or pulse shift keying (PSK) modulation where the synchronized template generation may be needed. The approach or method of various embodiments may offer a promising solution for low-power and high-data-rate communication in different applications, including biomedical applications such as for a neuroprobe or neurodevice microsystem which may require wireless communication.

Various embodiments may provide a cost-effective, low power and simple architecture, which may include analog auto-synchronization to the transmitter template pulses with an analog carrier recovery approach, without the complex as well as area-hungry and power-hungry digital back-end and/or without an external reference crystal oscillator. Various embodiments may be suitable for burst-mode or pulsed FSK or PSK modulation for improving the bit error ratio (BER) and immunity to interference, thereby providing increased performance. The architecture of various embodiments may be used in many applications which may require low-power and high-data-rate wireless communication.

The transceiver or receiver of various embodiments may include one or more of the following: (1) auto-synchronization to the transmitter template pulses with an analog carrier recovery approach; (2) no area- and power-hungry digital back-end and complex algorithms required; (3) no external reference crystal oscillator required, and therefore cost effective; (4) detection of the energy from the incoming pulses; (5) acquisition of the frequency component of data rate from the incoming pulses; (6) generation of a local template signal to lock with the phase and frequency of the received pulses; or (7) generation of an aligned active receiver window and a local oscillator (LO) signal for demodulation.

Examples of system parameters for neural recording devices will now be described.

In order to capture neural spike signals with a duration of about 250 μs, each channel of the neural recording device may include a 10-bit resolution ADC with a sampling rate of about 40 KHz, which may be high enough to obtain real time neural spike. For simultaneous recording and transmitting signals from 25 channels, the neural recording device may generate a raw data rate of about 10 Mbit/s (=40 Ksample/s/channel×10 bits/sample×25 channels). Although all the channels may not need to be sampled at all times, a high data-rate transmission may nevertheless be required for such a high number of channels. An application of the receiver (e.g. burst-mode wideband FSK receiver) of various embodiments may be to receive data from a biomedical implant at data rates in excess of about 10 Mbps.

The receiver (e.g. burst-mode wideband BFSK receiver) of various embodiments may operate at sub-1 GHz band. The employed pulses may occupy a wide band ranging from about 379 MHz to about 600 MHz with two carrier frequencies of about 433.92 MHz and about 542.4 MHz. This band may enable the power consumption of the radio frequency (RF) building blocks to be maintained as low as possible. Furthermore, the low band may suffer from less path loss and tissue absorption. At a higher frequency, the electromagnetic energy absorbed by the tissue may rise rapidly, increasing power consumption and the possibility of negative effects on the tissue.

Ultra-wide band (UWB) communication systems play an increasing role in today's short range communication systems, for example in personal area network (PAN) applications. By definition, the RF bandwidth for a UWB centered at the centre frequency, f_{c}, should be at least 20% of this central frequency or larger than about 500 MHz. The Federal Communications Commission (FCC) regulation limits an effective isotropically radiated power (EIRP) of approximately −41.3 dBm/MHz that is allowed in the 0˜960 MHz band. The maximum power of a UWB signal optimally occupying the minimal 500-MHz bandwidth may not exceed −14 dBm.

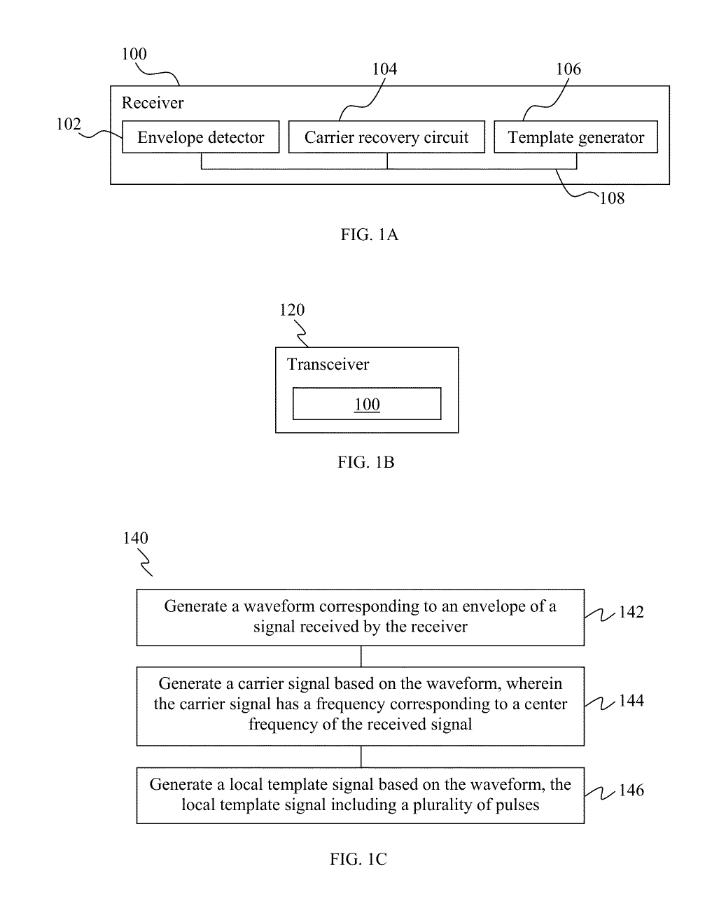

FIG. 1A shows a schematic block diagram of a receiver 100, according to various embodiments. The receiver 100 includes an envelope detector 102 configured to generate a waveform corresponding to an envelope of a signal received by the receiver 100, a carrier recovery circuit 104 configured to generate a carrier signal based on the waveform, wherein the carrier signal has a frequency corresponding to a center frequency of the received signal, and a template generator 106 configured to generate a local template signal based on the waveform, the local template signal including a plurality of pulses. The line represented as 108 is illustrated to show the relationship between the envelope detector 102, the carrier recovery circuit 104 and the template generator 106, which may include electrical coupling and/or mechanical coupling.

In various embodiments, the received signal or the signal received by the receiver 100 may include a train of pulses.

In various embodiments, the envelope detector 102 may be coupled to the carrier recovery circuit 104. The template generator 106 may be coupled to the envelope detector 102 or the carrier recovery circuit 104 or both.

In various embodiments, the template generator 106 may also receive the carrier signal. The local template signal may be generated based on the carrier signal.

In various embodiments, the waveform generated by the envelope detector 102 may be used as a reference frequency for carrier recovery or carrier signal generation, e.g. as a reference frequency for a phase-locked loop (PLL) for carrier signal generation.

In various embodiments, the local template signal may be configured to act as a controlling signal for processing (e.g. mixing) of the received signal and the carrier signal by the receiver 100. For example, the received signal and the carrier signal may be processed by the receiver 100 during certain or pre-determined durations or periods of the local template signal.

The receiver 100 may further include at least one mixer configured to receive the received signal, the carrier signal and the local template signal. The received signal and the carrier signal may be mixed by the at least one mixer to form a composite output signal. The mixing process may occur during periods of times defined by the local template signal, for example the received signal and the carrier signal may be mixed during each pulse of the plurality of pulses of the local template signal. This may mean that the local template signal may act as a control signal for controlling the mixing process of the received signal and the carrier signal, for example the timing of the mixing process.

In various embodiments, the at least one mixer may include an in-phase mixer and a quadrature-phase mixer. The in-phase (I) mixer may be arranged in an in-phase path (I-path) of the receiver 100 while the quadrature-phase (Q) mixer may be arranged in a quadrature-phase path (Q-path) of the receiver 100. Each of the in-phase mixer (I-mixer) and the quadrature-phase mixer (Q-mixer) may be an addition/subtraction mixer. The I-mixer and the Q-mixer may be balanced relative to each other, in other words having at least substantially similar characteristics.

The in-phase mixer and the quadrature-phase mixer may be configured to be activated during each pulse of the plurality of pulses. This may mean that during each pulse (representative of a “HIGH” signal) of the local template signal, the in-phase mixer and the quadrature-phase mixer may be activated to be in an “ON” state.

The in-phase mixer (I-mixer) may be configured to subtract the received signal from an in-phase component of the carrier signal so as to generate a first mixed signal, and wherein the quadrature-phase mixer (Q-mixer) may be configured to subtract the received signal from a quadrature-phase component of the carrier signal so as to generate a second mixed signal. The first mixed signal and the second mixed signal may be in phase quadrature relative to each other, or in other words, shifted in phase by 90° relative to one another.

In various embodiments, the receiver 100 may further include a first amplifier (e.g. a first variable-gain amplifier (VGA)) configured to receive the first mixed signal from the in-phase mixer, and a second amplifier (e.g. a second variable-gain amplifier (VGA)) configured to receive the second mixed signal from the quadrature-phase mixer. The first amplifier may amplify the first mixed signal present along the I-path so as to produce a first amplified signal, while the second amplifier may amplify the second mixed signal present along the Q-path so to produce a second amplified signal. The first amplifier and the second amplifier may also receive the local template signal.

The receiver 100 may further include a phase detector configured to compare respective phases of the respective outputs (e.g. in the form of the first amplified signal and the second amplified signal) of the first amplifier and the second amplifier so as to generate a voltage signal. This may mean that the phase detector may be configured to receive the respective outputs from the first amplifier and the second amplifier, and further configured to compare the phase of the output from the first amplifier with the phase of the output from the second amplifier.

The receiver 100 may further include a Schmitt trigger configured to detect an amplitude of the voltage signal, which is an output from the phase detector, and convert the voltage signal to a demodulated signal. The demodulated signal may be based on or may correspond to the received signal. The demodulated signal may carry information or data that may be modulated or encoded with the received signal. In the context of various embodiments, the term “Schmitt trigger” may mean a comparator which may receive an input and compares the input against a certain or pre-determined threshold level, and which may produce an output based on whether the input is above or below the threshold level.

In the context of various embodiments, the envelope detector 102 may include a squarer configured to multiply the received signal with an identical version of the received signal to produce a squared output, a filter (e.g. a low pass filter; LPF) coupled to the squarer, the filter configured to filter the squared output, and a comparator configured to detect an amplitude of the filtered squared output so as to generate the waveform corresponding to the envelope of the received signal.

In the context of various embodiments, the template generator 106 may be or may include a pulse generator or a pulse generating circuit.

In the context of various embodiments, the receiver 100 may further include another amplifier (e.g. a low-noise amplifier; LNA) for amplifying the received signal.

In the context of various embodiments, the receiver 100 may be configured to receive a frequency shift keying (FSK) modulated burst-mode signal or a frequency shift keying (FSK) modulated pulse wideband signal.

In the context of various embodiments, the receiver 100 may be configured to operate in a frequency range of between about 300 MHz and about 800 MHz, for example between about 300 MHz and about 500 MHz, between about 300 MHz and about 400 MHz, between about 600 MHz and about 800 MHz, or between about 400 MHz and about 500 MHz.

In the context of various embodiments, the waveform may be or may include a pulse waveform representative of the envelope of the received signal.

In the context of various embodiments, the local template signal may be synchronized (e.g. auto-synchronized) with the received signal. This may mean that the local template signal may be synchronized (e.g. auto-synchronized) to a transmitter template signal which may form part of the received signal.

In the context of various embodiments, the receiver 100 may be or may include an ultra-wideband (UWB) receiver.

In the context of various embodiments, the receiver 100 may be a clocked correlating receiver.

FIG. 1B shows a schematic block diagram of a transceiver 120, according to various embodiments. The transceiver 120 includes the receiver 100 which may be as described in the context of the embodiment of FIG. 1A.

FIG. 1C shows a flow chart 140 illustrating a method of controlling a receiver, according to various embodiments.

At 142, a waveform corresponding to an envelope of a signal received by the receiver is generated.

At 144, a carrier signal is generated based on the waveform, wherein the carrier signal has a frequency corresponding to a center frequency of the received signal.

At 146, a local template signal is generated based on the waveform, the local template signal including a plurality of pulses.

In various embodiments, the received signal and the carrier signal may be mixed during periods/durations of times defined by the local template signal. This may mean that the local template signal may act as a control signal for controlling the mixing of the received signal and the carrier signal.

In various embodiments, at 142, the process of generating the waveform may include multiplying the received signal with an identical version of the received signal to produce a squared output, filtering (e.g. low pass filtering) the squared output, and detecting an amplitude of the filtered squared output so as to generate the waveform.

In various embodiments, the method may further include mixing the received signal and the carrier signal during an “ON” state corresponding to each pulse of the plurality of pulses of the local template signal. This may mean that each pulse defines an “ON” state where mixing occurs.

In various embodiments, the method may further include generating or deriving an in-phase component of the carrier signal, generating or deriving a quadrature-phase component of the carrier signal, during an “ON” state corresponding to each pulse of the plurality of pulses of the local template signal, mixing the in-phase component and the received signal to generate a first mixed signal, and mixing the quadrature-phase component and the received signal to generate a second mixed signal.

In various embodiments, mixing the in-phase component and the received signal may include subtracting the received signal from the in-phase component, and wherein mixing the quadrature-phase component and the received signal may include subtracting the received signal from the quadrature-phase component.

In various embodiments, the method may further include amplifying the first mixed signal to produce a first amplified signal, and amplifying the second mixed signal to produce a second amplified signal.

In various embodiments, the method may further include comparing respective phases of the first amplified signal and the second amplified signal so as to generate a voltage signal. The method may further include detecting an amplitude of the voltage signal and converting the voltage signal to a demodulated signal.

In the context of various embodiments, the received signal may be a frequency shift keying (FSK) modulated burst-mode signal or a frequency shift keying (FSK) modulated pulse wideband signal.

In the context of various embodiments, the waveform may be or may include a pulse waveform representative of the envelope of the received signal.

In the context of various embodiments, the local template signal may be synchronized with the received signal.

In the context of various embodiments, the receiver may be or may include an ultra-wideband (UWB) receiver.

In the context of various embodiments, the frequency of the carrier signal may be higher than the pulse repetition rate of the local template signal.

In the context of various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a ‘circuit’ in accordance with an alternative embodiment.

In the context of various embodiments, the terms “couple” and “coupled” may include electrical coupling and/or mechanical coupling.

In the context of various embodiments, the terms “couple” and “coupled” with regard to two or more components may include direct coupling and/or indirect coupling. For example, two components being coupled to each other may mean that there is a direct coupling path between the two components and/or there is an indirect coupling path between the two components, e.g. via one or more intervening components connected therebetween.

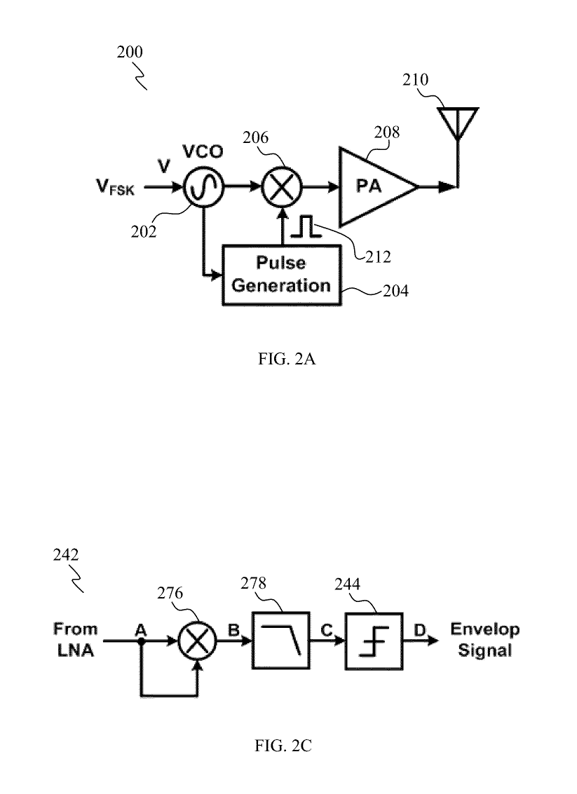

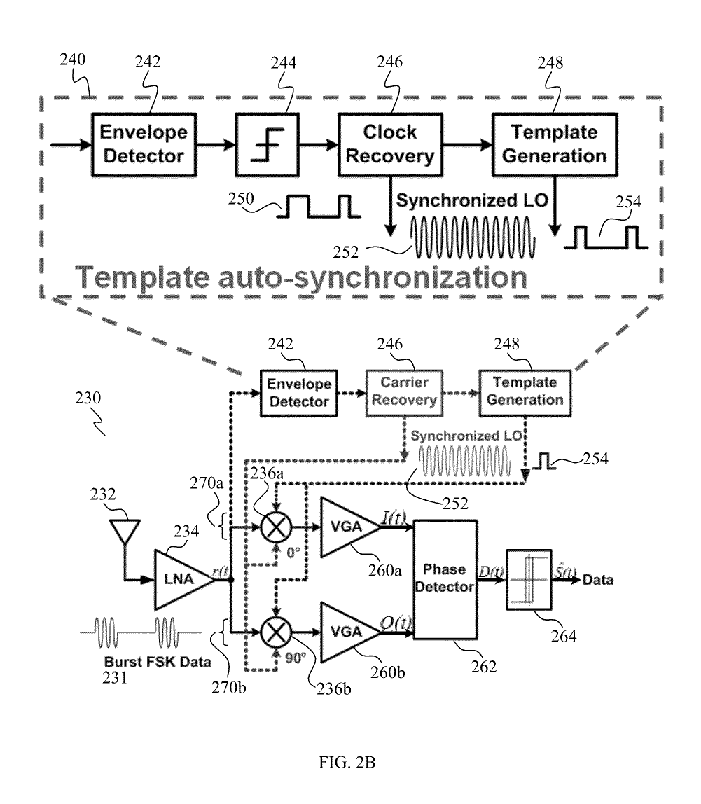

Non-limiting examples of the transceiver architecture (e.g. burst-mode or pulsed wideband FSK transceiver) will now be described with reference to FIGS. 2A to 2C.

FIG. 2A shows a schematic block diagram of a transmitter 200, according to various embodiments. A low complexity UWB transmitter implementation using direct frequency modulation may be employed. The transmitter 200 may include a voltage-controlled oscillator (VCO) 202, a pulse generator (or pulse generating circuit) 204, a mixer 206, a power amplifier (PA) 208, and an antenna (e.g. transmitting antenna) 210. Respective inputs of the pulse generator 204 and the mixer 206 may be coupled to the VCO 202. Another input of the mixer 206 may be coupled to an output of the pulse generator 204. The output of the mixer 206 may be coupled to the PA 208 for signal amplification. The output of the PA 208 may be coupled to the antenna 210 for transmission of the transmission signal.

A random bit stream, e.g. V_{FSK}, may be applied on the control voltage, V, of the VCO 202, whose output may be shaped by a rectangular pulse. For example, the output signal from the VCO 202 may be provided to the mixer 206 and to the pulse generator 204 which may generate one or more pulses, as represented by 212, based on the output signal from the VCO 202. The mixer 206 also receives the pulse(s) 212 generated by the pulse generator 204, which is mixed with the output signal received from the VCO 202 to generate a mixed signal whose waveform may be shaped by the pulse(s) 212.

In UWB, the pulse duration may be scaled to the desired RF bandwidth. In order to relax the constraints attached to the short pulse duration and to comply with the UWB minimum bandwidth, a binary FSK modulation in conjunction with a rectangular pulse may be employed. A bit “0” may be determined by a pulse centered at (f_{c}−f₀) while a “1” data bit may be defined by a pulse centered at (f_{c}+f₀), where f_{c} refers to the center frequency and f₀ refers to the deviation frequency relative to f_{c}. As a non-limiting example, f_{c} may be about 450 MHz. Such a modulation may easily create a signal with the minimum required bandwidth to comply with the UWB rules or guidelines, while having ideally rectangular spectrum mask occupancy. The implementation may be all digital to save or minimise chip area and power consumption.

FIG. 2B shows a schematic block diagram of a receiver 230, according to various embodiments. The receiver 230 may be a burst-mode FSK receiver incorporating auto-synchronized template generation, for example with auto-synchronization to incoming pulses or signal. The receiver 230 may include a crystal-less (e.g. free of a crystal oscillator) carrier recovery and an analog demodulation circuitry.

The receiver 230 may include an antenna (e.g. receiving antenna) 232 which may be coupled to a low noise amplifier (LNA) 234 so as to provide the signal received by the receiving antenna 232 to the LNA 234 which may amplify the received signal. It should be appreciated that the LNA 234 may be optional. An in-phase mixer (I-mixer) 236a and a quadrature-phase mixer (Q-mixer) 236b may be coupled to the LNA 234 for receiving the received signal, r(t), which for example may be burst FSK data as represented by 231.

The receiver 230 may further include a template auto-synchronization module 240 for generating an auto-synchronized template signal. The module 240 may include an envelope detector 242, a comparator 244, a clock recovery or carrier recovery circuit 246 and a template generator or template generation circuit 248. It should be appreciated that the comparator 244 may be provided as an internal part of the envelope detector 242 or external to the envelope detector 242.

The envelope detector 242 may receive r(t), and together with the comparator 244, may generate a waveform 250 (e.g. a pulse waveform) corresponding to or representative of the envelope of the received signal, r(t). The carrier recovery circuit 246 may generate a carrier signal 252, e.g. a synchronized local oscillator (LO) signal. The synchronized local oscillator (LO) signal 252 may have a frequency corresponding to a center frequency, f_{c}, of r(t). The template generator 248 may generate a local template signal 254 based on the pulse waveform 250. The local template signal 254 may be in the form of a pulse waveform having a plurality of pulses. As the local template signal 254 is generated based on the pulse waveform 250, the local template signal 254 may be synchronized to the pulse waveform 250, and therefore also to r(t) received by the receiver 230. This may also mean that local template signal 254 may be synchronized to the signal (e.g. transmitter template signal or pulses) transmitted by a transmitter (e.g. transmitter 200 of FIG. 2A), and received as r(t) by the receiver 230. In various embodiments, the carrier recovery circuit 246 may provide synchronized LO from the envelop signal (waveform 250), while the template generator 248 may be used to control the operation duration of the I-mixer 236a and/or the Q-mixer 236b. In various embodiments, the local template signal 254 may be a divided version of the carrier signal 252, with duty cycle control.

The I-mixer 236a and the Q-mixer 236b may receive the carrier signal 252. For example, the I-mixer 236a may receive an in-phase component of the carrier signal 252 while the Q-mixer 236b may receive a quadrature-phase component of the carrier signal 252. The I-mixer 236a and the Q-mixer 236b may also receive the local template signal 254.

The I-mixer 236a and the Q-mixer 236b may be activated during each pulse of the plurality of pulses of the local template signal 254. This may mean that the I-mixer 236a and the Q-mixer 236b may be in an “ON” state for performing signal mixing process during durations corresponding to pulses (or “HIGH” value) of the local template signal 254. Thus, the local template signal 254 may act as a control signal.

The I-mixer 236a may mix r(t) and the carrier signal 252 in the durations corresponding to the pulses of the local template signal 254, for example subtracting r(t) from the in-phase component of the carrier signal 252, so as to generate a first mixed signal. The Q-mixer 236b may mix r(t) and the carrier signal 252 in the durations corresponding to the pulses of the local template signal 254, for example subtracting r(t) from the quadrature-phase component of the carrier signal 252, so as to generate a second mixed signal. The I-mixer 236a and the Q-mixer 236b may perform the respective mixing processes at least substantially simultaneously.

The I-mixer 236a may be coupled to an amplifier, for example a first variable-gain amplifier (VGA) 260a, for receiving the first mixed signal from the I-mixer 236a, and amplifying the first mixed signal to generate a first amplified signal, I(t). The Q-mixer 236b may be coupled to another amplifier, for example a second variable-gain amplifier (VGA) 260b, for receiving the second mixed signal from the Q-mixer 236b, and amplifying the second mixed signal to generate a second amplified signal, Q(t). The I-mixer 236a and the first VGA 260a may be arranged in an in-phase path (I-path) 270a of the receiver 230 while the Q-mixer 236b may be arranged in a quadrature-phase path (Q-path) 270b of the receiver 230.

The first VGA 260a and the second VGA 260b may be coupled to a phase detector 262 for comparing the phase of I(t) and the phase of Q(t) and generating a voltage signal, D(t), based on the comparison. The phase detector 262 may be coupled to a comparator, for example a Schmitt trigger 264, which may detect the amplitude of D(t), and convert the D(t) to a demodulated signal, S(t). The Schmitt trigger 264 may compare the amplitude of D(t) against a pre-determined threshold level and may produce an output, corresponding to the demodulated signal, S(t), based on this comparison. Information or data may be extracted from S(t).

A challenging part may be to generate the synchronized template pulses of the local template signal 254. Short duration pulses may require power hungry hardware for signal detection and synchronization. Conventionally, a complex tuning algorithm with a digital back-end to control the timing of the synchronization template is indispensable and the minimum tuning step should be fine enough to prevent performance degradation. As a result, it increases the design complexity and power consumption for conventional architectures. For the architecture of various embodiments of the clocked correlating receiver, the auto-synchronization may be achieved by a close-loop carrier recovery.

FIG. 2C shows a schematic block diagram of the envelope detector 242, according to various embodiments. The envelope detector 242 may include a squarer 276, a low-pass filter (LPF) 278, and a comparator 244. The envelope detector 242 may receive and square the received signal, r(t) (denoted as Signal “A” in FIG. 2C), from the LNA 234, where r(t) and a copy or an identical version of r(t) may be received by the squarer 276 which may then multiply the two signals to produce a squared output (Signal “B”). The squared output may then be filtered by LPF 278 to filter out any undesired high frequency harmonics, thereby producing a filtered output (Signal “C”). The filtered squared output (Signal “C”) may then be subjected to the comparator (or slicer) 244 which may detect its amplitude or power level so as to generate an envelope signal (Signal “D”) such as the waveform 250 illustrated in FIG. 2B. The comparator 244 may compare the amplitude of the filtered output against a certain threshold value for generating the envelope signal.

As a non-limiting example using the burst FSK data 231, the envelope detector 242 may extract from the burst FSK signal 231 the envelope waveform at the frequency of bit rate. Without loss of generality, if the center frequency of the transmitter is a multiple of the bit rate, the envelope signal may be treated as a reference frequency for a phase-locked loop (PLL) to generate the synchronized template pulses 254. In embodiments where the ratio of the center frequency to the bit rate may be a fractional number, a fractional PLL may also accomplish this carrier recovery circuitry with a fractional divider, although at the expense of a more complex design.

The behaviour simulation and measurement results of the receiver of various embodiments will now be described by way of the following non-limiting examples.

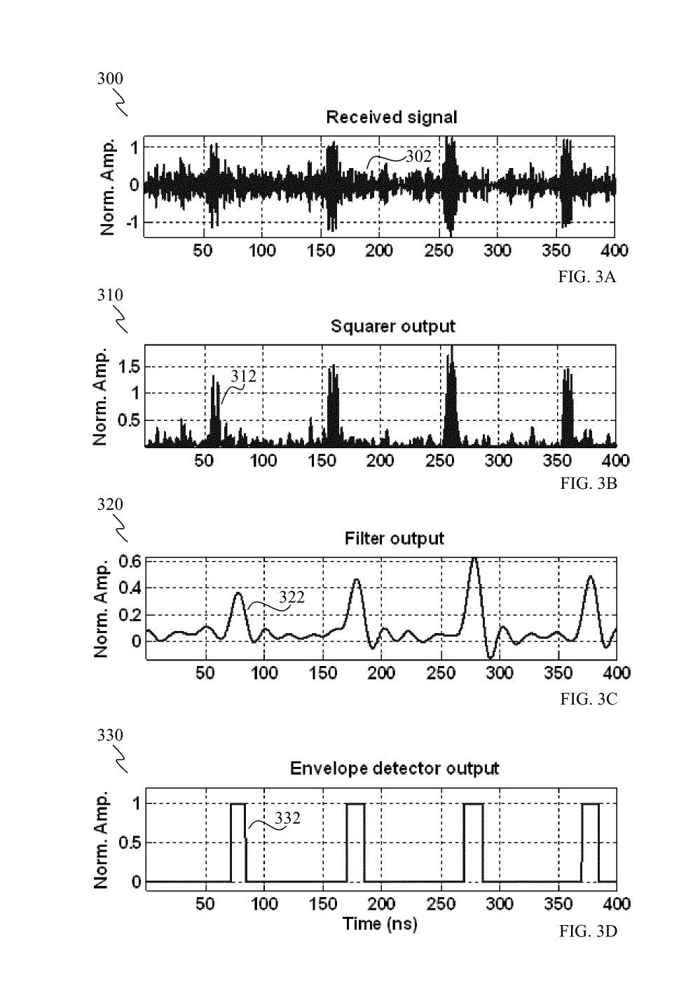

The transient response of the envelope detector 242, including additive white Gaussian noise (AWGN), is as shown in FIGS. 3A to 3D. FIG. 3A shows a plot 300 of a received signal, r(t) (Signal “A”) 302, FIG. 3B shows a plot 310 of the squared output (Signal “B”) 312, FIG. 3C shows a plot 320 of the filtered output (Signal “C”) 322, while FIG. 3D shows a plot 330 of the envelope signal (Signal “D”) 332 corresponding to r(t) 302.

The generated envelope signal 332 may have a frequency of bit rate and may be synchronized with the transmitter pulses. Therefore, the generated envelope waveform 332 may be used as a reference frequency for carrier recovery in the receiver 230, so as to generate the synchronized template pulses 254. This method not only provides synchronization with template pulses to reduce complex digital back-end tuning circuitry, but also remove the bulky and costly crystal oscillator provided in the conventional approach.

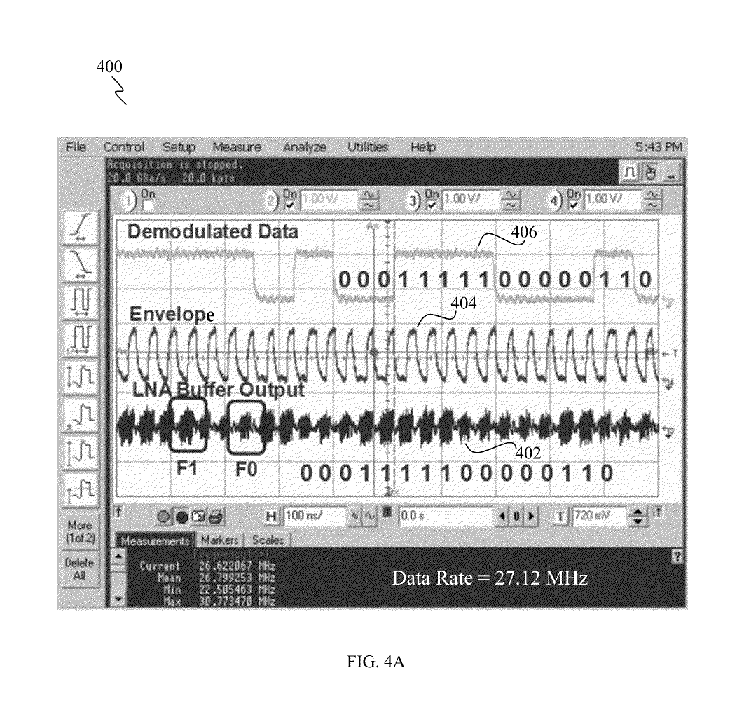

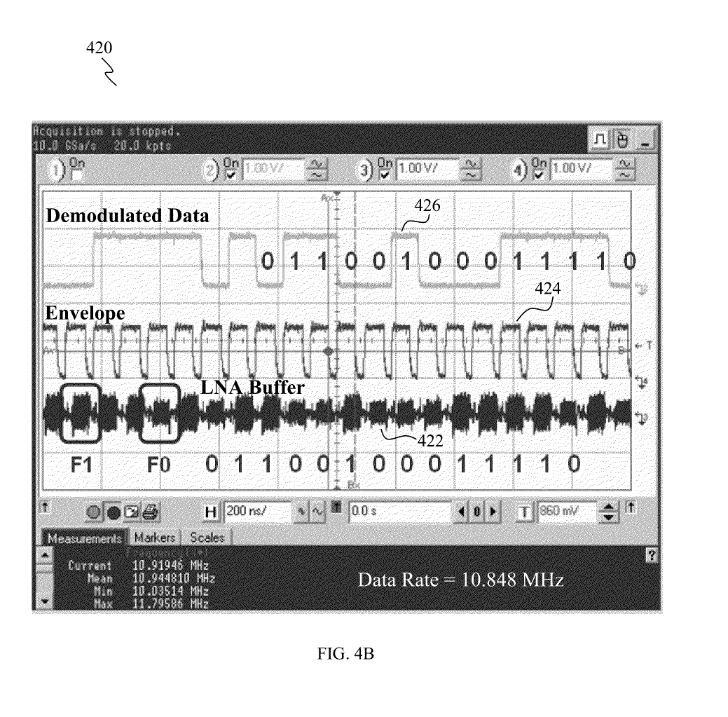

FIG. 4A shows a plot 400 of the measured transient responses of the receiver of various embodiments for a data rate of about 27.12 MHz, illustrating the results for a burst-mode FSK receiver with auto-synchronization to incoming pulses. FIG. 4A shows the LNA buffer's output 402, the envelope 404 extracted from the incoming pulses, and the demodulated data output 406 as verified at the data rate of 27.12 MHz. The envelope signal 404 may be representative of the envelope of the LNA buffer's output 402. The signal within the box labeled “F0” corresponding to the LNA buffer's output 402 represents the transmitter (TX) output frequency in FSK for data “0” while the signal within the box labeled “F1” represents the transmitter (TX) output frequency in FSK for data “1”.

FIG. 4B shows a plot 420 of the measured transient responses of the receiver of various embodiments for a data rate of about 10.848 MHz, illustrating the results for a burst-mode FSK receiver with auto-synchronization to incoming pulses. FIG. 4B shows the LNA buffer's output 422, the envelope 424 extracted from the incoming pulses, and the demodulated data output 426. The envelope signal 424 may be representative of the envelope of the LNA buffer's output 422. The signal within the box labeled “F0” corresponding to the LNA buffer's output 422 represents the transmitter (TX) output frequency in FSK for data “0” while the signal within the box labeled “F1” represents the transmitter (TX) output frequency in FSK for data “1”.

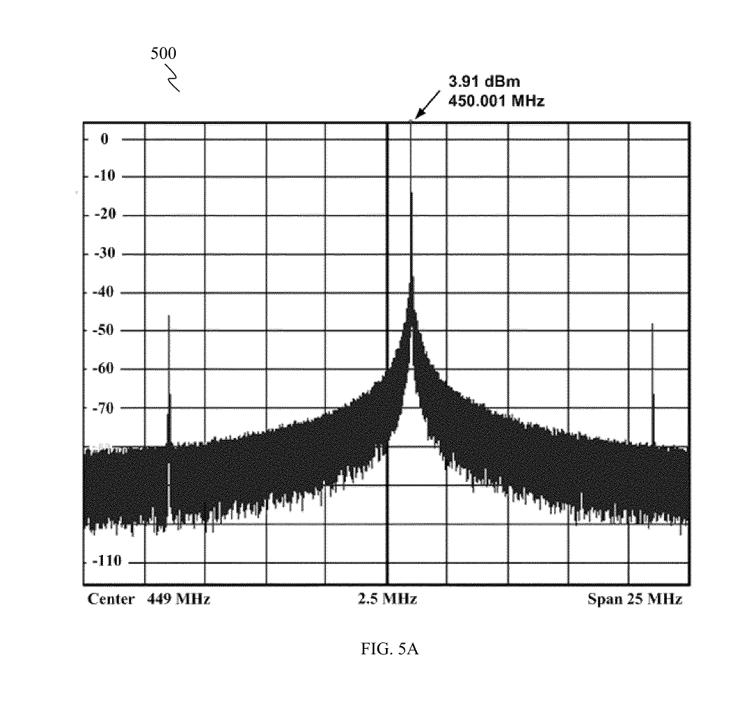

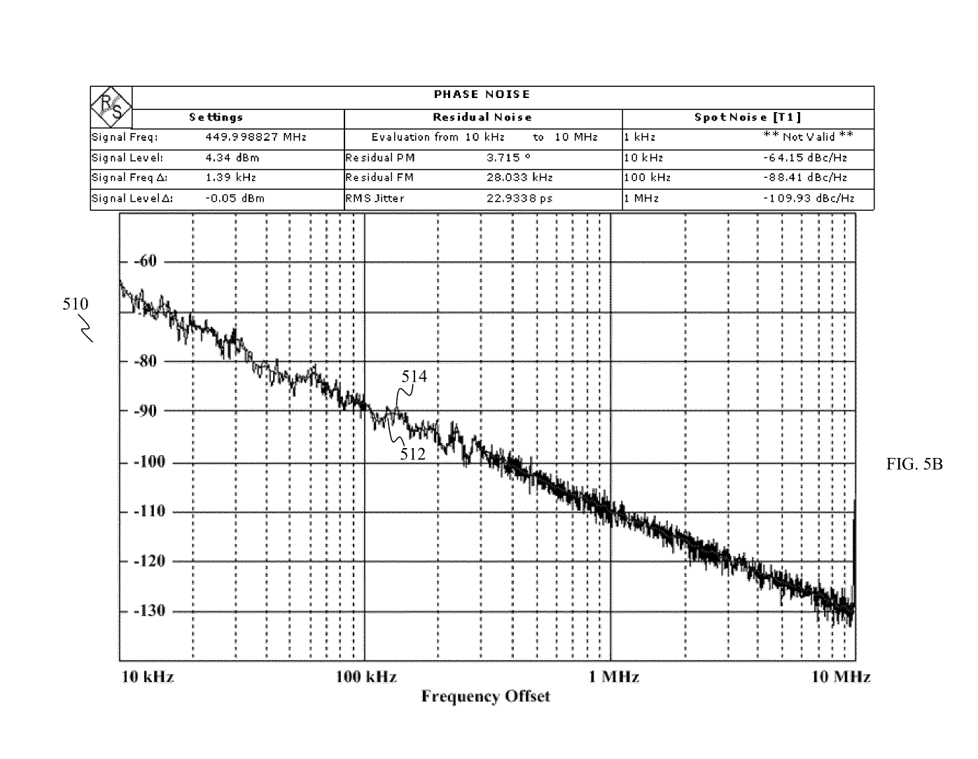

FIGS. 5A and 5B show respectively a plot 500 of local oscillator output spectrum and a plot 510 of voltage-controlled oscillator (VCO) phase noise for a receiver with external 10 MHz reference and a center frequency, f_{c}, of about 450 MHz. The plot 510 of FIG. 5B shows curve (smooth) 512 for average phase noise and curve (jagged) 514 for instantaneous phase noise. As may be observed from FIGS. 5A and 5B, the out signal power is approximately 3.91 dBm and the phase noise at about 100 kHz offset is approximately −88.41 dBc.

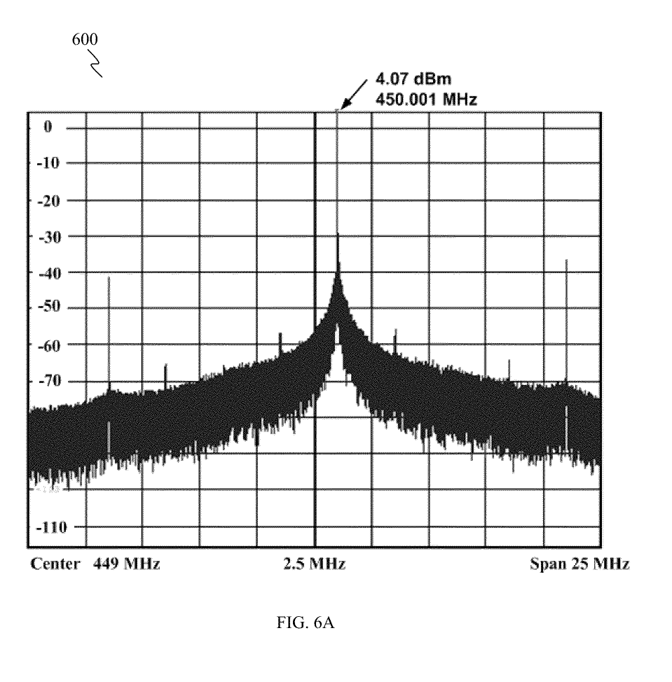

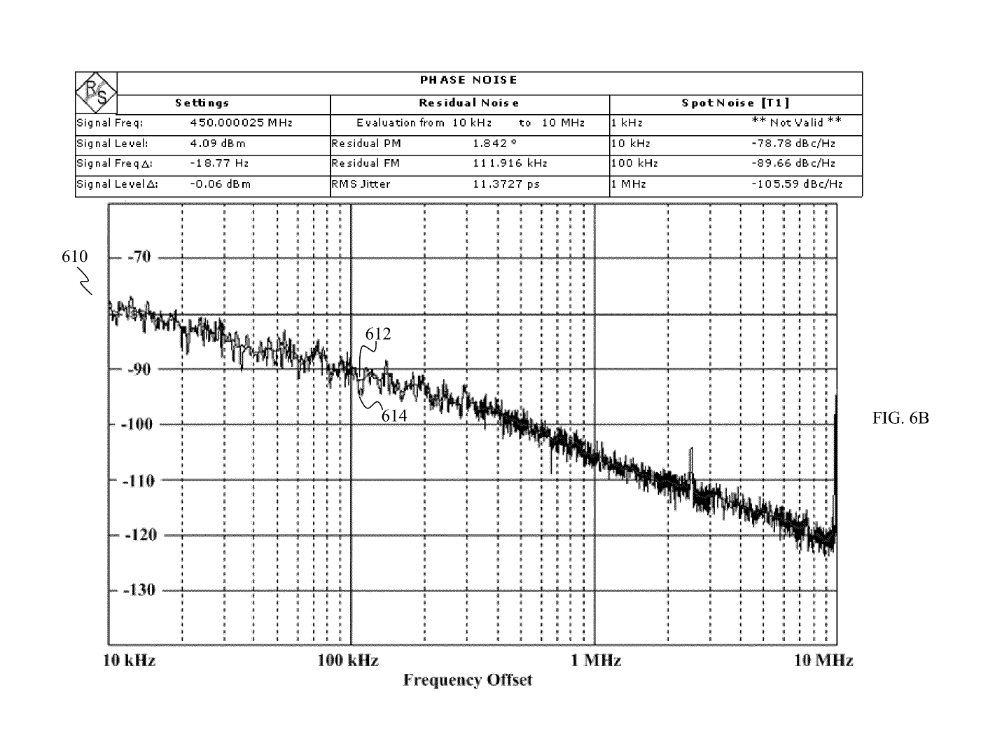

FIGS. 6A and 6B show respectively a plot 600 of local oscillator output spectrum and a plot 610 of voltage-controlled oscillator (VCO) phase noise for a receiver with internal 10 MHz envelope and a center frequency, f_{c}, of about 450 MHz. The plot 610 of FIG. 6B shows curve (smooth) 612 for average phase noise and curve (jagged) 614 for instantaneous phase noise. As may be observed from FIGS. 6A and 6B, the out signal power is approximately 4.05 dBm and the phase noise at about 100 kHz offset is approximately −89.66 dBc. The results illustrated in FIGS. 6A and 6B show a better phase noise performance.

The bit error rate (BER) of the receiver of various embodiments will now be described. In order to quantify the receiver performance, the uncoded BER may be estimated as a function of E_{b}/N₀, where E_{b} is the energy per bit and N₀ is the power spectral density (PSD) level of the noise of the AWGN communication channel.

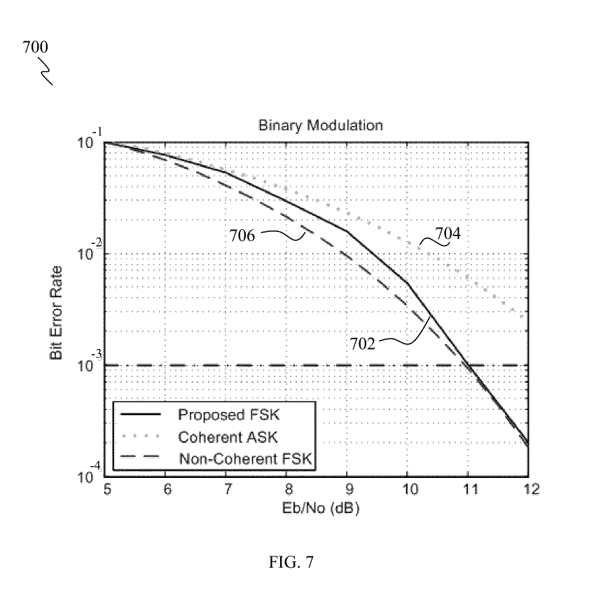

FIG. 7 shows a plot 700 of simulated bit error rate (BER) as a function of E_{b}/N₀ at a 10-Mbps data rate for the receiver of various embodiments, illustrating the BER result 702 for the receiver of various embodiments with FSK modulation. For comparison purposes, the result 704 for ideal coherent ASK modulation and the result 706 for non-coherent FSK modulation are also shown in FIG. 7.

As shown in FIG. 7, the minimum E_{b}/N₀ for which a BER lower than approximately 10⁻³ is estimated to be about 11 dB. The BER simulated curve 702 approaches to non-coherent FSK modulation under high E_{b}/N₀. However, the result 702 shows higher BER when the signal to noise is low. This performance degradation may be due to the envelope detection, since it may be harder to obtain an envelope signal under high noise environments.

The link budget for various embodiments will now be described. In order to evaluate the performance of a communication link using the method and architecture of various embodiments, consideration may be made based on the system parameters which follow the UWB regulation. An effective isotropic radiated power (EIRP) of approximately −41.3 dBm/MHz may be allowed in the 0-960 MHz frequency band. The EIRP takes the antenna gain into account, which may allow making abstraction of the antenna in the calculation of the link budget. Taking a 3 dB margin for not completely filling the spectrum, an average transmitting power, P_{TX}, of about −17.3 dBm may be radiated when using approximately 500 MHz of bandwidth. In addition, by assuming free-space propagation condition, the path loss for the operating frequency of about 550 MHz at a distance of about 1 m is about 27.25 dB. Further, an additional skin absorption loss of about 20 dB for implants may be considered. The channel noise, PN, in a 500 MHz wide band may be equal to about −87 dBm. When BFSK is used, a value of about 11 dB for (E_{b}/N₀) may be required for a raw BER better than 10⁻³. For a pulse rate of about 10 Mbps, this may translate to approximately −6 dB signal-to-noise ratio (SNR). Implementation loss, I, of about 6 dB may be taken into consideration as well. Under these assumptions, the link budget for a pulse repetition rate of about 10 Mbps may be about 22.4 dB (=−17.3−27.25−20+87+6−6), based on Equation 1 below.

Link Margin=P_{TX}−PathLoss−SkinLoss−PN−SNR−I (Equation 1).

This link margin of about 22.4 dB may be sufficient for designing a low-power UWB receiver with a noise figure (NF) smaller than about 19 dB while taking approximately 3-dB design margin. The required sensitivity may be better than −67.6 dBm based on the above calculation.

In various embodiments, burst-mode or pulsed radio technology may provide simple, low-cost and low-power solutions. Synchronized template generation may be required to align the active receiver window with the transmitter template pulses. Various embodiments may provide auto-synchronized local oscillator (LO) and template generation technique without dedicated and power-hungry/area-hungry hardware. This technique may be used in any burst-mode or pulsed radios with FSK or PSK modulation, such as for example UWB-IR or burst-mode radios. The system design parameters, simulated and measured results as described above show that the burst-mode or pulsed wideband FSK receiver or transceiver of various embodiments may be an outstanding candidate for low-power and high-data-rate biomedical applications with high robustness.

Various embodiments of the receiver or transceiver may be suitable for frequency shift keying (FSK) modulation. Various embodiments of the receiver or transceiver may include analog auto-synchronization, without the need for an external oscillator (e.g. external reference crystal oscillator) and/or without the need for digital control. In addition, no transmitter data clock may be required. Furthermore, various embodiments of the receiver or transceiver may be without area- and power-hungry digital back-end and/or without power-hungry high speed analog-to-digital converter (ADC).

Various embodiments of the receiver or transceiver may be designed for or with one or more of the following parameters: (1) frequency band of 400-600 MHz; (2) process based on 180 nm CMOS; (3) pulse rate of about 27.12 Mp/s; (4) energy per pulse (energy/pulse) of approximately 0.53 nJ; (5) receiver (Rx) power of about 14.4 mW; (6) modulation based on binary frequency shift keying (BFSK); (7) sensitivity (Pin,peak) of approximately −52 dBm (measured) and −70 dBm (simulated); (8) no external reference oscillator; (9) no digital processing for template synchronization; or (10) area of 4 mm² for a burst-mode FSK receiver with auto-synchronization.

It should be appreciated that modifications to the receiver or transceiver of various embodiments may be carried out to improve performances. For example, envelope detector improvement may be carried out for better sensitivity (approximately −60 dBm). As there may be challenges with envelope detectors being sensitive to interference, improvements may be carried out to provide an envelope detector with reduced sensitivity to interference or with immunity to interference.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A receiver comprising:
an envelope detector configured to generate a waveform corresponding to an envelope of a signal received by the receiver;
a carrier recovery circuit configured to generate a carrier signal based on the waveform, wherein the carrier signal has a frequency corresponding to a center frequency of the received signal; and
a template generator configured to generate a local template signal based on the waveform, the local template signal comprising a plurality of pulses.

2. The receiver of claim 1, further comprising at least one mixer configured to receive the received signal, the carrier signal and the local template signal.

3. The receiver of claim 2, wherein the at least one mixer comprises an in-phase mixer and a quadrature-phase mixer.

4. The receiver of claim 3, wherein the in-phase mixer and the quadrature-phase mixer are configured to be activated during each pulse of the plurality of pulses.

5. The receiver of claim 3, wherein the in-phase mixer is configured to subtract the received signal from an in-phase component of the carrier signal so as to generate a first mixed signal, and wherein the quadrature-phase mixer is configured to subtract the received signal from a quadrature-phase component of the carrier signal so as to generate a second mixed signal.

6. The receiver of claim 5, further comprising:
a first amplifier configured to receive the first mixed signal from the in-phase mixer; and
a second amplifier configured to receive the second mixed signal from the quadrature-phase mixer.

7. The receiver of claim 6, further comprising a phase detector configured to compare respective phases of respective outputs of the first amplifier and the second amplifier so as to generate a voltage signal.

8. The receiver of claim 7, further comprising a Schmitt trigger configured to detect an amplitude of the voltage signal and convert the voltage signal to a demodulated signal.

9. The receiver of claim 1, wherein the envelope detector comprises:
a squarer configured to multiply the received signal with an identical version of the received signal to produce a squared output;
a filter coupled to the squarer, the filter configured to filter the squared output; and
a comparator configured to detect an amplitude of the filtered squared output so as to generate the waveform.

10. The receiver of claim 1, wherein the local template signal is synchronized with the received signal.

11. A transceiver comprising the receiver of claim 1.

12. A method of controlling a receiver, the method comprising:
generating a waveform corresponding to an envelope of a signal received by the receiver;
generating a carrier signal based on the waveform, wherein the carrier signal has a frequency corresponding to a center frequency of the received signal; and
generating a local template signal based on the waveform, the local template signal comprising a plurality of pulses.

13. The method of claim 12, wherein generating the waveform comprises:
multiplying the received signal with an identical version of the received signal to produce a squared output;
filtering the squared output; and
detecting an amplitude of the filtered squared output so as to generate the waveform.

14. The method of claim 12, further comprising mixing the received signal and the carrier signal during an “ON” state corresponding to each pulse of the plurality of pulses of the local template signal.

15. The method of claim 12, further comprising:
generating an in-phase component of the carrier signal;
generating a quadrature-phase component of the carrier signal; and
during an “ON” state corresponding to each pulse of the plurality of pulses of the local template signal, mixing the in-phase component and the received signal to generate a first mixed signal, and mixing the quadrature-phase component and the received signal to generate a second mixed signal.

16. The method of claim 15, wherein mixing the in-phase component and the received signal comprises subtracting the received signal from the in-phase component, and wherein mixing the quadrature-phase component and the received signal comprises subtracting the received signal from the quadrature-phase component.

17. The method of claim 15, further comprising amplifying the first mixed signal to produce a first amplified signal; and amplifying the second mixed signal to produce a second amplified signal.

18. The method of claim 17, further comprising comparing respective phases of the first amplified signal and the second amplified signal so as to generate a voltage signal.

19. The method of claim 18, further comprising detecting an amplitude of the voltage signal and converting the voltage signal to a demodulated signal.

20. The method of claim 12, wherein the local template signal is synchronized with the received signal.
